(19) United States
(12) Patent Application Publication
(10) Pub. No.: US 2026/0104305 A1
(43) Pub. Date: Apr. 16, 2026

(54) PRESSURE SENSOR AND METHOD FOR DETERMINING PRESSURE

(71) Applicant: Agilent Technologies, Inc., Santa Clara, CA (US)

(72) Inventors: Clemens Plachetka, Malsch (DE); Tony Ziegler, Steinfeld (DE); Joachim-Richard Wagner, Ettlingen (DE)

(21) Appl. No.: 19/115,766

(22) PCT Filed: Sep. 27, 2023
(86) PCT No.: PCT/IB2023/059606

§ 371 Date: Mar. 26, 2025

(30) Foreign Application Priority Data
Sep. 30, 2022 (DE) 102022125311.2

(51) Int. Cl. G01L 9/00; G01L 19/06; G01N 30/02; G01N 30/32

(52) U.S. Cl. CPC G01L 9/0072; G01L 19/0645; G01N 30/32; G01N 2030/027; G01N 2030/326

(57) ABSTRACT

A pressure sensor includes an electromechanical element, which is configured to change its shape depending on a pressure applied to the pressure sensor and to output an electromagnetic characteristic that is based on the shape change. The pressure sensor also includes frame element with a surface, against which the electromechanical element is pressed by the applied pressure to cause the shape change.

### CROSS-REFERENCE TO RELATED APPLICATIONS

This application is the national stage under 35 U.S.C. 371 of International Application No. PCT/IB2023/059606, filed on Sep. 27, 2023; which claims priority to German Patent Application No. 10 2022 125 311.2, filed on Sep. 30, 2022; the entire contents of each of which are incorporated by reference herein.

### TECHNICAL FIELD

The present disclosure relates to a pressure sensor, a sample separation device or system and a method for determining pressure.

### BACKGROUND

Known pressure sensors for measuring liquid pressures include the introduction of force through a separating membrane, which has a considerable inherent stiffness. On the one hand, the membrane must be elastic for the pressure transmitted to be undamped, and on the other hand, the force transducer must have mechanical stability, which is a feature of a solid-state behavior. In order to meet these contradictory requirements, oil is often introduced downstream of the separating membrane. The force transducer is located in the oil on the wall side. Such known pressure sensors are bulky in terms of their dimensions and their construction and are associated with considerable costs in terms of production.

### SUMMARY

There may be a need to provide a compact and inexpensive pressure sensor which can be used advantageously in particular in sample separation devices or systems.

According to an exemplary embodiment of the present disclosure, a pressure sensor is provided which comprises (i) an electromechanical element, which is configured to change its shape depending on a pressure applied to the pressure sensor and to output an electromagnetic characteristic, which is based on the shape change, and (ii) a frame element with a surface, against which the electromechanical element is pressed by the applied pressure in order to cause the shape change.

According to another exemplary embodiment of the present disclosure, a sample separation device or system for separating a fluidic sample located in a mobile phase into fractions is provided, wherein the sample separation device or system comprises a pressure sensor with the features described above for determining a pressure of the mobile phase and/or the fluidic sample. The pressure sensor can be arranged in front of a pumping system of the sample separation device or system, in particular upstream of the pumping system.

According to yet another exemplary embodiment, a method for determining pressure is provided, wherein the method comprises (i) providing a pressure sensor with an electromechanical element and a frame element, (ii) measuring an electromagnetic characteristic of the electromechanical element, wherein the electromagnetic characteristic depends on a shape change of the electromechanical element, wherein the shape change is caused by the electromechanical element being pressed against a surface of the frame element by a pressure applied to the pressure sensor, and (iii) detecting the applied pressure from the measured electromagnetic characteristic.

In the context of the present application, the term “pressure sensor” can be understood in particular as a device for determining liquid pressures and/or gas pressures and/or for determining characteristics correlating with such pressures. For example, a pressure can be determinable indirectly via the measurement of an electrical characteristic such as a capacitance, an inductance or a charge. The pressure sensor can also be suitable for determining a pressure which a solid body applies.

A pressure sensor can have a “sensitivity” or “responsivity”, in particular an ability to resolve small pressure differences. Sensitivity can be defined as a change of a value of an output variable of a measuring device in relation to the change of a value of an input variable causing it. The sensitivity can be determined by a characteristic curve of the pressure sensor or a sensor characteristic, for example a characteristic curve which is linear at least in sections or an exponential characteristic curve. The pressure sensor can furthermore have a “measuring range” which is characterized by a maximum pressure and/or a minimum pressure which can be determined by means of the pressure sensor.

In the context of the present application, the term “electromechanical element” may denote in particular a component of the pressure sensor which, in reaction to a mechanical variable acting on the electromechanical element, in particular pressure, outputs an electromagnetic variable, for example a capacitance. The electromagnetic variable can depend on the acting mechanical variable. A pressure applied to the electromechanical element can cause a shape change of the electromechanical element which at least partially causes a corresponding change of the electromagnetic variable. The electromechanical element can be configured for example as a block, in particular a cylindrical block, or as a membrane, in particular a circular membrane.

The electromechanical element can contain a material which comprises an electroactive polymer. In the context of the present application, an “electroactive polymer” (EAP) may denote in particular a polymer which changes its shape by the application of an electrical voltage and/or a polymer which is characterized by an electromagnetic variable which correlates with a shape change of the polymer. Advantageously, such an electroactive polymer can be elastic, in particular enable a strong extension with free formability, whereby small pressure changes can be resolvable. In an embodiment, such an electroactive polymer can be formed as a dielectric elastomer, in particular as a silicone elastomer or acrylic elastomer. Descriptively speaking, an electroactive polymer between two or more electrodes can form a capacitor, whose capacitance can depend on a shape change of the electroactive polymer between the two or more electrodes. Such a capacitor can have an especially high responsivity to pressure changes, for example due to the high extensibility of electroactive polymers.

The electromechanical element can comprise a dielectric elastomer sensor element (DES). The dielectric elastomer sensor element can be configured to convert mechanical work into an electromagnetic characteristic, for example electrical energy, and/or vice versa. The dielectric elastomer sensor element can comprise an elastomer layer, which is arranged between two electrodes, in particular elastic electrodes. A material of the elastomer layer can be incompressible or at least approximately incompressible. The material can have a low dielectric constant. The material can be especially extensible, for example having a unidirectional extensibility greater than 10%, in particular greater than 30%, in particular greater than 100%. The unidirectional extensibility can be less than 300%. It can be in the range of 300%, in particular with a deviation of less than 10%. Extensibility can be defined as a maximum length change of a material, without it breaking or tearing. The material can comprise or consist of at least one of a silicone elastomer and an acrylic elastomer. Descriptively speaking, a dielectric elastomer sensor element can be a flexible capacitor.

In the context of the present application, the term “shape change” may denote in particular a change of the outer shape of a body, for example an extension and/or a compression of the body. The shape change can be incompressible or almost incompressible, i.e. volume-maintaining. For example, a volume change in the shape change can be less than 10% of the initial volume, in particular less than 1% of the initial volume. The shape change can also encompass a volume change greater than 10%.

In the context of the present application, the term “electromagnetic characteristic” may denote in particular any electrical or also magnetic property of the electromechanical element. The electromagnetic characteristic can be or comprise at least one of a capacitance, an inductance and a charge. The fact that the electromagnetic characteristic is based on the shape change can mean in particular that the characteristic depends on and/or correlates with the shape change. For example, the shape change can cause a capacitance change when the electromechanical element forms a capacitor.

In the context of the present application, the term “frame element” may denote in particular a component of the pressure sensor which at least partially encloses and/or at least partially covers the electromechanical element. The frame element can be a cap or a cover which at least partially covers the electromechanical element. The frame element can comprise a recess, in particular a blind hole or a through hole. For example, the recess can be a blind hole with a bottom surface or base surface. The bottom surface can be the surface against which the electromechanical element is pressed by the applied pressure to be measured. The recess can be cylindrical and/or the bottom face can be circular. The recess can have a complementary shape to the electromechanical element so that the electromechanical element can be at least partially, in particular completely, introduced into the recess. When the electromechanical element is introduced in the recess, only the surface of the electromechanical element on which pressure is applied by the liquid or the gas may be completely exposed. The pressure can be imparted by a separating element covering this surface, in particular a membrane.

The “surface of the frame element against which the electromechanical element presses” can be opposite with respect to the electromechanical element to the surface of the electromechanical element on which pressure is applied by the liquid or the gas. It may be a surface of the recess, in particular be or encompass a bottom face of the recess. The electromechanical element can press against the surface of the frame element with a corresponding surface of the electromechanical element. This corresponding surface can be opposite to the surface of the electromechanical element on which pressure is applied by the liquid or the gas, and/or be opposite to the completely exposed surface of the electromechanical element.

In the context of the present application, the term “measuring” may denote the direct measurement of a variable and/or the indirect determination from one or multiple measured values which correlate with the variable to be measured. In the context of the present application, the term “determining”may encompass a calculation of a variable.

In the context of the present application, the term “sample separation device” (or “sample separation system”, or “sample separation apparatus”) may denote in particular a device or system which is able and configured to separate a fluidic sample, for example to separate it into different fractions. For example, the sample separation can be carried out by means of chromatography or electrophoresis. For example, the sample separation device or system can be a liquid chromatography sample separation device or system.

In the context of the present application, the term “fluidic sample” denotes in particular a medium which contains the matter actually to be analyzed (for example a biological sample, such as for example a protein solution, a pharmaceutical sample, etc.).

In the context of the present application, the term “mobile phase” denotes in particular a fluid (further in particular a liquid) which serves as a carrier medium for transporting the fluidic sample from a fluid drive (for example a piston pump) to a sample separation unit (e.g., chromatography column) of the sample separation device or system. For example, the mobile phase can be a (for example organic and/or inorganic) solvent or a solvent composition (for example water and ethanol).

According to an exemplary embodiment of the present disclosure, a pressure sensor can be created which can resolve small pressure changes at a small diameter of the exposed surface of the electromechanical element, wherein the exposed surface can be separated from the sample by a separating element, for example a membrane. The pressure sensor can have an increased sensitivity and/or a large measuring range for the pressure measurement. It can be executable in an especially compact manner due to the simple construction. Furthermore, it can be inexpensively manufacturable, inter alia because the complicated introduction of oil can be avoided by using the electromechanical element.

Additional embodiments of the pressure sensor, of the sample separation device or system and of the method are described below.

According to an exemplary embodiment, a material of the electromechanical element comprises an electroactive polymer, in particular a dielectric elastomer. The material may be one of multiple materials of which the electromechanical element consists, or be the only material of which the electromechanical element consists. The material may consist exclusively of the electroactive polymer, possibly with the addition of fillers, or comprise further constituents. Such an embodiment can be advantageous due to the high extensibility and/or free formability of such materials which can contribute to an increased sensitivity of the pressure sensor, for example in comparison with piezoelectric ceramics. Such materials can additionally have an advantageous thermal behavior, so that temperature differences and measurement deviations resulting therefrom can be avoided.

According to an exemplary embodiment, the electromechanical element comprises an electrically insulating layer and two electrically conductive layers, between which the electrically insulating layer is arranged. The electrically insulating layer and/or the electrically conductive layers can be formed in a foil-like manner. The electrically conductive layers can be provided by applying an electrically conductive material to the electrically insulating layer. At least one of a conductive carbon black, a graphite powder, a silicone oil-graphite mixture, a gold layer and an ionic gel can be used for the electrically conductive layers.

A construction according to the described exemplary embodiment can correspond to a capacitor. The electrically conductive layers can be contacted by respective electrical contact elements, for example in order to measure a capacitance. The contacting can be carried out via lugs pressed into the electromechanical element and/or via thin electrically conductive platelets, in particular polymer platelets, which are applied to the electrically conductive layers. The contacting of the two electrically conductive layers can be carried out from different sides, in particular in order to reduce or avoid mutual influencing. The contact elements can be connected to conductor traces which lead out of the electromechanical element. The conductor traces can be realized, for example, by means of conductive carbon black.

A multiplicity of electrically insulating layers, for example two, three, four or at least five electrically insulating layers, which are each separated from one another by corresponding further electrically conductive layers, can be arranged between the two electrically conductive layers. The further electrically conductive layers can likewise be contacted by electrical contact elements in order to measure corresponding capacitances. Such a stack-like construction can contribute to increasing the sensitivity and/or widening the measuring range of the pressure sensor. The stack-like construction can correspond to a cascading of capacitors.

According to an exemplary embodiment, a material of the electrically conductive layers comprises a material of the electrically insulating layer as matrix material and an electrically conductive filler in the matrix material. In this way, the electrically conductive layers can be configured to be sufficiently flexible or elastic with simultaneous electrical conductivity in order not to impede the shape change behavior of the electrically insulating layer during the pressure measurement. In particular, within the scope of the described embodiment, the shape change behavior of the electrically conductive layers can correspond to the shape change behavior of the electrically insulating layer, for example with respect to elasticity. If the surface of the frame element comprises a sensitivity-increasing and/or measurement range-extending spatial structure, the electrically conductive layer must additionally be sufficiently elastic in order to be pressed into these spatial structures.

According to an exemplary embodiment, the matrix material is at least one of a silicone and an acrylic and/or the electrically conductive filler is at least one of conductive carbon black, graphite, iron oxide particles, aluminum particles, silver powder, stainless steel fibers and carbon fibers. These materials can be especially advantageous with respect to the shape change behavior of the electromechanical element.

According to an exemplary embodiment, the electromagnetic characteristic is a capacitance. If the electromechanical element is constructed as described above, the electromechanical element corresponds to a capacitor, whose capacitance depends on the pressure applied to the electromechanical element and the corresponding shape change. The capacitance change can be at least partially caused by a change of the distance between the electrically conductive layers.

According to an exemplary embodiment, the surface of the frame element against which the electromechanical element is pressed and/or a corresponding surface of the electromechanical element comprises a sensitivity-increasing and/or measurement range-extending spatial structure. The corresponding surface can be that surface of the electromechanical element which is pressed against the surface of the frame element.

According to an exemplary embodiment, the sensitivity-increasing and/or measurement range-extending spatial structure comprises at least one cavity between electromechanical element and frame element, wherein with increasing applied pressure the electromechanical element is pressed into the cavity. The shape change caused by the pressure applied to the pressure sensor can encompass pressing into the cavity. If no pressure is applied to the electromechanical element, the cavity can have a maximum volume. The spatial structure can comprise a multiplicity of spatially separated cavities, in particular two, three, four, at least five or at least ten. A characteristic curve of the pressure sensor can be adjustable by shape and size of the cavity or cavities. At least two, in particular at least three, in particular at least five of the cavities can have different geometrical dimensions, for example a different surface, a different depth or a different diameter along the surface of the frame element against which the electromechanical element is pressed.

According to an exemplary embodiment, at least one cavity, in particular all cavities, is connected to an environment of the pressure sensor, for example by a channel arranged in the frame element. Descriptively speaking, therefore, the at least one cavity is vented. The environment can have an ambient pressure which does not correspond to the applied pressure to be determined. The ambient pressure can be, for example, an air pressure. Such an exemplary embodiment can be advantageous in order to determine a relative pressure in comparison with the ambient pressure. By contrast, if a connection to the environment is missing, an absolute pressure can be determinable.

According to an exemplary embodiment, the spatial structure comprises a plurality of indentations and/or a plurality of elevations, which are arranged in the surface of the frame element against which the electromechanical element is pressed and/or the corresponding surface of the electromechanical element. Such indentations and/or elevations can provide one or multiple cavities into which the electromechanical element is moved with increasing applied pressure. A characteristic curve of the pressure sensor can be adjustable by shape and size of the indentations and/or elevations.

According to an exemplary embodiment, the indentations and/or elevations are arranged concentrically. They can be arranged concentrically around a center or a center of gravity of the surface of the frame element and/or the corresponding surface of the electromechanical element, wherein these surfaces can be circular. The indentations and/or elevations can be formed annularly. Adjacent indentations and/or elevations can have an equal distance from one another. An indentation and/or elevation can be arranged in the center or center of gravity. In the described concentric arrangement of indentations and/or elevations, at low pressures the electromechanical element can be pressed more strongly into a central cavity, at next higher pressures then respectively into the nearest outer annular cavity and finally at high pressure into the outermost annular cavity. In this way, at least approximately a linear characteristic curve of the sensor or a linear sensor characteristic can be achievable.

According to an exemplary embodiment, two of the indentations and/or two of the elevations comprise at least one of different geometrical dimensions and a different distance to an edge of the surface of the frame element against which the electromechanical element is pressed and/or the corresponding surface of the electromechanical element. For example, they can have a different depth or height. They can have a different outline, for example circular, oval or irregular. The outline can extend in the respective surface or at least parallel thereto. The outline can have a different surface, for example a different diameter, wherein the diameter can be defined in the respective surface. Three, in particular at least five, of the indentations and/or three, in particular at least five, of the elevations can each have different geometrical dimensions. A sensor characteristic or a characteristic curve of the sensor can be adaptable by such unequal structures. In particular, a linear sensor characteristic can be achieved approximately and for a delimited region.

According to an exemplary embodiment, the indentations and/or elevations form a nub structure. A nub structure can comprise hump-like elevations and/or hump-like indentations. A linear sensor characteristic can also be approximately realizable by such a nub structure.

According to an exemplary embodiment, a thickness of the electromechanical element is one to ten times, in particular one and a half times to three times, a profile depth defined by the indentations and/or the elevations. For example, the profile depth can correspond to a sum of maximum depth of the indentations and maximum height of the elevations. Alternatively, the profile depth can correspond to a sum of average depth of the indentations and average height of the elevations. For example, the profile depth can be 0.3 mm and the thickness of the electromechanical element can be 0.45 mm to 0.9 mm. The thickness can be defined perpendicular to the surface of the frame element when the electromechanical element lies against this surface. Such a ratio between thickness of the electromechanical element and profile depth can be advantageous in order to improve the effects of the profile on the sensor characteristic.

According to an exemplary embodiment, a diameter of the exposed surface of the electromechanical element is smaller than 20 mm. The thickness of the electromechanical element can be 0.45 mm to 0.9 mm. The thickness of an optionally present separating element can be smaller than 1 mm, in particular between 0.2 mm and 0.3 mm. The profile depth can be between 0.2 mm and 0.5 mm. Correspondingly, an especially compact pressure sensor can be provided.

According to an exemplary embodiment, the electromechanical element is pressed against the frame element with a bias, in particular in order to make a negative pressure applied to the pressure sensor measurable. The bias can act in a direction which is perpendicular to the surface of the frame element against which the electromechanical element is pressed by the applied pressure to be measured. The bias can exist if no pressure to be measured is applied to the pressure sensor. A working point of the sensor characteristic can be shiftable by such a bias in order to make the negative pressure measurable. The shift of the working point can correspond to the bias. The maximum measurable negative pressure can be determined by the bias.

According to an exemplary embodiment, the bias is at least partially generated by a membrane, which is attached to the frame element and at least partially covers the electromechanical element. For this purpose, the electromechanical element can protrude from a recess of the frame element. In other words, a side wall of the recess can be shortened compared to the introduced electromechanical element. The membrane can at least partially cover a surface of the electromechanical element which is exposed or exposed for the pressure measurement. It can be configured to hold and/or position the electromechanical element. Furthermore, the membrane can be a separating element which separates the electromechanical element from a liquid or a gas, whose pressures are to be measured. The membrane can be attached to the frame element by attachment elements, which in particular also serve as adjustment elements. It can be attached by clamping between the frame element and a base element, into which the frame element is inserted.

According to an exemplary embodiment, the bias is at least partially generated by the electromechanical element being clamped into the frame element. The electromechanical element can be clamped laterally, in particular by a form fit between side walls of a recess of the frame element and corresponding surfaces of the electromechanical element. For such a form fit, for example, holding elements such as teeth can be attached to the side walls of the recess.

According to an exemplary embodiment, the bias is at least partially generated by an elevation on the surface of the frame element against which the electromechanical element is pressed. Such an elevation can cause a deformation of the abutting surface of the electromechanical element which determines the bias. The bias can be generated by the elevation in combination with a membrane, which holds or positions the electromechanical element.

According to an exemplary embodiment, the bias can be at least partially generated electromagnetically, for example by applying an electrical voltage to a capacitor formed by means of the electromechanical element.

According to an exemplary embodiment, the pressure sensor further comprises a separating element, in particular a membrane, which covers the electromechanical element in a liquid-tight and/or gas-tight manner. The pressure sensor comprises the separating element. The electromechanical element can be at least partially, in particular completely, introduced into a recess of the frame element, wherein the separating element covers the recess. A material of the membrane can comprise an elastomer, in particular perfluoro-rubber (perfluoro-elastomer, or FFKM) and/or rubber encased with at least one of polytetrafluoroethylene (PTFE, e.g., TEFLON material), silicone and fluorosilicone. Alternatively or additionally, a material of the membrane can comprise a non-elastomer, in particular at least one of steel, a metal, polyether ether ketone (PEEK), fluoroethylene propylene (FEP), polypropylene (PP) and polyethylene (PE). The separating element can be or comprise a metal foil, in particular a metal foil with a suitable coating. The separating element can protect the electromechanical element and/or the recess of the frame element from a liquid and/or from a gas, whose pressure is to be determined by the pressure sensor. For this purpose, the separating element can be produced from a robust and/or corrosion-resistant material.

According to an exemplary embodiment, the membrane comprises a microstructure, in particular at least one bead. Such an exemplary embodiment can be advantageous if the material of the membrane does not comprise an elastomer in order to ensure a low stiffness of the membrane. Accordingly, the microstructure, for example the bead, can likewise reduce the stiffness, in particular in order to cause a simpler deflection and a higher sensitivity of the sensor. However, even if the membrane comprises an elastomer, such a microstructure can improve the sensitivity of the sensor. The microstructure can be configured to at least partially convert a tensile stress into a bending stress.

According to an exemplary embodiment, the electromechanical element is molded on an abutting surface profile of the separating element, in particular a microstructure of the surface profile of the separating element. The electromechanical element can be molded on one or multiple beads in the surface profile of the separating element. For this purpose, a surface of the electromechanical element abutting the surface profile of the separating element can be shaped complementary to the surface profile of the separating element. The molding can be achieved by a common production process of separating element and electromechanical element. The molding can improve a sensor quality.

According to an exemplary embodiment, the electromechanical element adheres to the separating element by means of adhesion.

According to an exemplary embodiment, the pressure sensor further comprises a base element, into which the frame element is inserted.

According to an exemplary embodiment, the electromechanical element is at least partially introduced into a recess of the frame element, wherein a gap is arranged between a side edge of the recess and the electromechanical element. The gap can be adjustable by a centering element, in particular corresponding centering elements in the frame element and the separating element. A further corresponding centering element can be arranged in a base element, into which the frame element is inserted. The gap can have a maximum extension if no pressure to be measured is applied to the electromechanical element. Such a gap can be advantageous, for example if the electromechanical element consists of an incompressible or at least slightly compressible material, because a cavity is hereby created, into which the material can yield when the electromechanical element is compressed.

According to an exemplary embodiment, a further surface of the frame element, against which the separating element lies, comprises a plurality of adjustment elements. A surface of the base element, against which the separating element lies, can likewise comprise a plurality of adjustment elements. Such adjustment elements can be, for example, teeth. The adjustment elements can be arranged in a meandering manner. The adjustment elements can be configured to fix the separating element, in particular a membrane, in a stress-free and self-adjusting manner.

According to an exemplary embodiment, the separating element is divided into measuring portions.

According to an exemplary embodiment, the pressure sensor is arranged before a pumping system of the sample separation device or system, in particular upstream of the pumping system. The pumping system can be configured to convey the mobile phase with a high pressure, in particular a pressure higher than 100 bar, in particular a pressure higher than 1000 bar, through a liquid path of the sample separation device or system, in particular a liquid path between the pumping system and the sample separation unit. The pressure sensor can thus be arranged in a liquid path with a low pressure before the pumping system, in particular with a pressure lower than 1000 bar, in particular lower than 100 bar, in particular lower than 10 bar. Such an arrangement can be advantageous, since the pressure sensor can be especially suitable for regions with a low pressure, inter alia due to the materials used and/or the sensitivity-increasing and/or measuring region-extending surface structure.

According to an exemplary embodiment, the sample separation device or system can comprise a sample separation unit for separating the sample located in the mobile phase. The sample separation unit can be formed as a chromatographic separation device, in particular as a chromatographic separation column. In a chromatographic separation, the chromatographic separation column can be provided with an adsorption medium. At this, the fluidic sample can be stopped and only subsequently it may be detached again in fractions more slowly or in the presence of a specific solvent composition, whereby the separation of the sample into its fractions is accomplished.

The sample separation device or system can be a microfluidic measuring device, a life science device, a liquid chromatography device, an HPLC (High-Performance Liquid Chromatography) device, a UHPLC (Ultra-High-Performance Liquid Chromatography) device, an SFC (Supercritical Liquid Chromatography) device, a gas chromatography device, an electrophoresis device and/or a gel electrophoresis device. However, many other applications are possible.

The pumping system can be configured, for example, to convey the mobile phase with, for example, several 100 bar up to 1000 bar and more, through the system.

The sample separation device or system can comprise a sample injector or a sample feeding unit for introducing the sample into the fluidic separation path. Such a sample injector can comprise an injection needle which can be coupled to a seat in a corresponding liquid path, wherein the needle can be moved out of this seat in order to receive sample. After the needle has been reintroduced into the seat, the sample can be located in a fluid path which can be switched into the separation path of the system, for example by switching a valve, which leads to the introduction of the sample into the fluidic separation path.

The sample separation device or system can comprise a fraction collector (or fractionating unit) for collecting the separated components of the fluidic sample. Such a fraction collector can guide the different components, for example, into different liquid containers. However, the analyzed sample can also be supplied to a drain container.

The sample separation device or system can comprise a detector for detecting the separated components. Such a detector can generate a signal which can be observed and/or recorded and which is indicative of the presence and quantity of the sample components in the fluid flowing through the system.

### BRIEF DESCRIPTION OF THE FIGURES

Other aims and many of the attendant advantages of embodiments of the present disclosure will become readily apparent and better understood by reference to the following more detailed description of embodiments in conjunction with the accompanying drawings. Features which are substantially or functionally the same or similar are provided with the same reference numerals.

FIG. 1 shows an HPLC system according to an exemplary embodiment of the present disclosure.

FIG. 2 shows a three-dimensional view of a partial region of a pressure sensor according to an exemplary embodiment of the present disclosure.

FIG. 3 shows a cross-sectional view of a pressure sensor with a sensitivity-increasing and/or measurement range-extending spatial structure according to an exemplary embodiment of the present disclosure.

FIG. 4 shows a characteristic curve of the pressure sensor shown in FIG. 3.

FIG. 5 shows a cross-sectional view of a pressure sensor with a different sensitivity-increasing and/or measurement range-extending spatial structure in comparison to the pressure sensor shown in FIG. 3, according to an exemplary embodiment of the present disclosure.

FIG. 6 shows a characteristic curve of the pressure sensor shown in FIG. 5.

FIG. 7 shows a cross-sectional view of a pressure sensor with a different sensitivity-increasing and/or measurement range-extending spatial structure in comparison to the pressure sensors shown in FIGS. 3 and 5, according to an exemplary embodiment of the present disclosure.

FIG. 8 shows a characteristic curve of the pressure sensor shown in FIG. 7.

FIG. 9 shows a cross-sectional view of a pressure sensor with a sensitivity-increasing and/or measurement range-extending spatial structure according to an exemplary embodiment of the present disclosure.

FIG. 10 shows a top view of a surface of a frame element with a sensitivity-increasing and/or measurement range-extending spatial structure according to an exemplary embodiment of the present disclosure.

FIG. 11 shows a top view of a surface of a frame element with a different sensitivity-increasing and/or measurement range-extending spatial structure in comparison to the frame element shown in FIG. 10, according to an exemplary embodiment of the present disclosure.

FIG. 12 shows a top view of a surface of a frame element with a different sensitivity-increasing and/or measurement range-extending spatial structure in comparison to the frame elements shown in FIGS. 10 and 11, according to an exemplary embodiment of the present disclosure.

FIG. 13 shows a cross-sectional view of a pressure sensor with a set bias according to an exemplary embodiment of the present disclosure.

FIG. 14 shows a characteristic curve of the pressure sensor shown in FIG. 13.

FIG. 15 shows a cross-sectional view of a pressure sensor for which a bias is set with a method according to exemplary embodiments of the present disclosure.

FIG. 16 shows a cross-sectional view of a pressure sensor for which a bias is set with a different method in comparison to FIG. 15, according to an exemplary embodiment of the present disclosure.

The illustrations in the drawings are schematic.

### DETAILED DESCRIPTION

Before exemplary embodiments of the present disclosure are described in more detail with reference to the drawing figures, some fundamental considerations of the present disclosure will be described in general, on the basis of which exemplary embodiments of the present disclosure have been developed.

According to an exemplary embodiment of the present disclosure, an assembly can be provided which forms a pressure sensor. This assembly consists of a cover (frame element), a silicone stack (electromechanical element) and a membrane (separating element) with beads for stiffness optimization. The membrane is fixed in a self-adjusting manner via retaining teeth (adjustment elements) which are arranged in a meandering manner. For exact and stress-free fixing, a catch feature (centering element) is located in the base body (base element). If pressure is applied on the membrane side, the DES which is formed by the silicone stack is thereby compressed, whereby the capacitance changes. For also higher pressures being measurable with elastic materials, a step structure (sensitivity-increasing and/or measurement range-extending spatial structure) is located on the cover which modulates the introduced voltage in the silicone stack such that the measuring range extends over a large pressure range.

According to an exemplary embodiment of the present disclosure, a pressure sensor encompasses a structured membrane (separating element) for the introduction of force and the capacitive effect of an electroactive polymer (EAP). For increasing the sensitivity, structures are applied to a frame element which sequentially compress the EAP (electromechanical element) after the introduction of pressure, upon pressure increase. A large measuring range is thereby guaranteed and the sensor is not completely deflected upon commencement of the introduction of force. Descriptively speaking, a progressive spring is realized in this way. The sensor element here is a stack (electromechanical element) of electroactive polymers, for example silicones, whose capacitance changes by compression. The membrane can here be divided into measuring portions. The membrane is fixed in a permanently fixed and self-adjusting manner and in a stress-free manner by special clamping elements (adjustment element). In order to ensure the freedom of movement of the membrane, beads are attached in the membrane which transform the load case of tension/pressure, which would promote creeping, into the load case of bending and increase the elasticity.

According to an exemplary embodiment, the membrane (separating element) has a very low flexural stiffness and the silicone of the electromechanical element is inherently elastic. Thereby, the smallest pressure changes can be resolved at a small membrane diameter. Temperature differences and measurement deviations resulting therefrom are avoided by the silicone of the electromechanical element.

According to an exemplary embodiment, a pressure sensor based on electroactive polymers (EAP) is provided. The EAP are located in a non-compressible or only very slightly compressible block (electromechanical element), for example a silicone block, and the pressure measurement is carried out via a shape change of the silicone block, which leads to a variation of the distances of the EAP capacitor plates. Multiple differently shaped recesses (cavities) can be provided into which the silicone block can “flow” under the influence of the pressure, which leads to a variation of the distances of the EAP capacitor plates. The plurality of different recesses can be located in the silicone block and/or the abutment piece (frame element), so that the pressure sensitivity can be suitably adapted via the pressure profile via the shaping of these different recesses.

FIG. 1 shows the basic construction of an HPLC system as a sample separation device or system 10, as can be used, for example, for liquid chromatography. A fluid pumping system (or fluid drive) 20, which is supplied with solvents from a supply unit 25, drives a mobile phase through a fluidic separation path to and through a sample separation unit 30 (such as, for example, a chromatographic column), which includes a stationary phase. A degasser 27 can degas the solvents before they are supplied to the fluid pumping system 20. A sample feeding unit 40 is arranged between the fluid pumping system 20 and the sample separation unit 30 in order to introduce a sample liquid into the fluidic separation path. The stationary phase of the sample separation unit 30 is provided for separating components of the sample. A detector 50, for example, a flow cell with fluorescence detection, detects separated components of the sample, and a fractionation device 60 can be provided for outputting separated components of the sample into containers provided therefor. The liquids can be output into a drain container or a fractionation device 60 after passing the detector 50.

While a liquid path between the fluid pumping system 20 and the sample separation unit 30 is typically under high pressure, the sample liquid is initially introduced under normal pressure into a region separated from the liquid path, a so-called sample loop, of the sample feeding unit 40, which then in turn introduces the sample liquid into the liquid path under high pressure. During the connection of the sample liquid initially under normal pressure in the sample loop into the liquid path under high pressure, the content of the sample loop is brought to the system pressure of the sample separation device or system 10 formed as an HPLC system. A control unit 70 controls the individual components 20, 25, 27, 30, 40, 50, 60, 100 of the sample separation device or system 10 formed here as a liquid chromatography sample separation device or system.

A pressure sensor 100 for determining a liquid pressure is arranged in a low-pressure region of the sample separation device or system 10 before the fluid pumping system 20. However, such pressure sensors can also be used at other points of the sample separation device or system 10, in particular likewise in the low-pressure region. However, use in a high-pressure liquid path, for example after the fluid pumping system 20, is also possible.

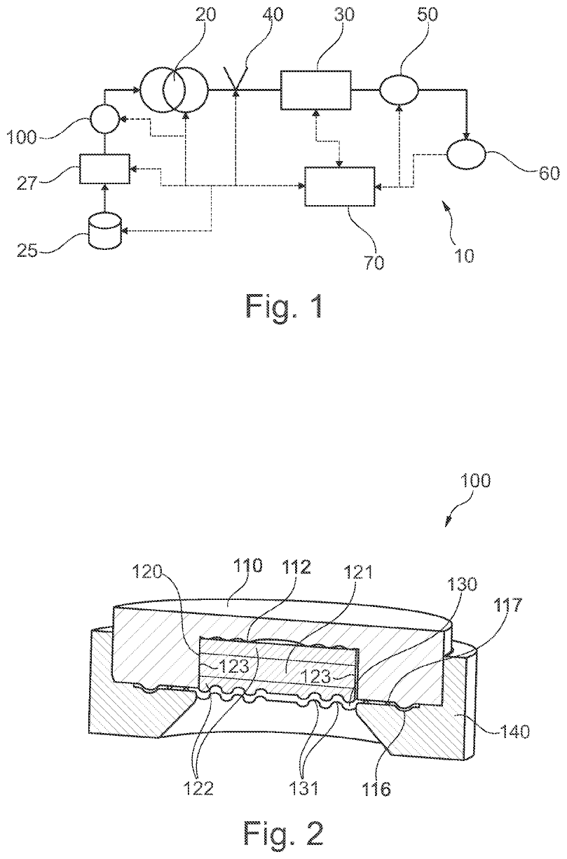

FIG. 2 shows a three-dimensional cross-sectional view of a pressure sensor 100, as it is used, for example, in the sample separation device or system 10 of FIG. 1. The pressure sensor 100 comprises an electromechanical element 120, which is configured to output an electromagnetic characteristic depending on a pressure applied to the electromechanical element 120. The applied pressure can be determined based on the electromagnetic characteristic. In the present case, the electromechanical element 120 comprises an electrically insulating layer 121, which is arranged between two electrically conductive layers 122. As a result, the electromechanical element 120 corresponds to a capacitor, whose capacitor plates are formed by the electrically conductive layers 122. The electromagnetic characteristic depending on the applied pressure is in this case the capacitance of the capacitor.

The pressure sensor 100 furthermore comprises a frame element 110 with a recess, in which the electromechanical element 120 is completely introduced so that the applied pressure presses the electromechanical element 120 against a surface 112 of the frame element 110 within the recess. Both the frame element 110 and the electromechanical element 120 are formed cylindrically.

A separating element 130, which is formed as a membrane, closes the recess of the frame element 110 in a liquid-tight manner so that the electromechanical element 120 located in the recess is protected from corrosive effects of a sample liquid. The membrane 130 comprises beads (or rims, or protrusions, or projections) 131 which increase the elasticity of the membrane 130 and correspondingly improve the sensitivity of the pressure sensor 100.

The frame element is inserted into a further recess of a base element 140. The base element 140 additionally comprises a funnel-shaped recess, which exposes a surface of the membrane 130, behind which surface the electromechanical element 120 is arranged. A liquid or a gas, whose pressure is to be determined, is located on the exposed surface of the membrane 130. By imparting force to the membrane 130, the pressure of the liquid or of the gas acts on the electromechanical element 120. At the edges laterally of the funnel-shaped recess, the membrane 130 is clamped between the frame element 110 and the base element 140.

A centering element 116, which is formed in the frame element 110, the base element 140 and the membrane 130, enables an exact positioning of the membrane 130 with respect to the frame element 110. Since the electromechanical element 120 is connected to the membrane 130 via adhesion, the centering element 116 in particular enables the adjustment of the gaps 123 between the frame element 110 and the electromechanical element 120. Adjustment elements 117 on the frame element 110 and the base element 140 engage into the membrane 130 and ensure a self-adjusting stress-free fixing of the membrane 130 over the recess of the frame element 110. Both the centering element 116 and the adjustment elements 117 are formed at the edges laterally of the funnel-shaped recess in the region, at which the membrane 130 is clamped between the frame element 110 and the base element 140.

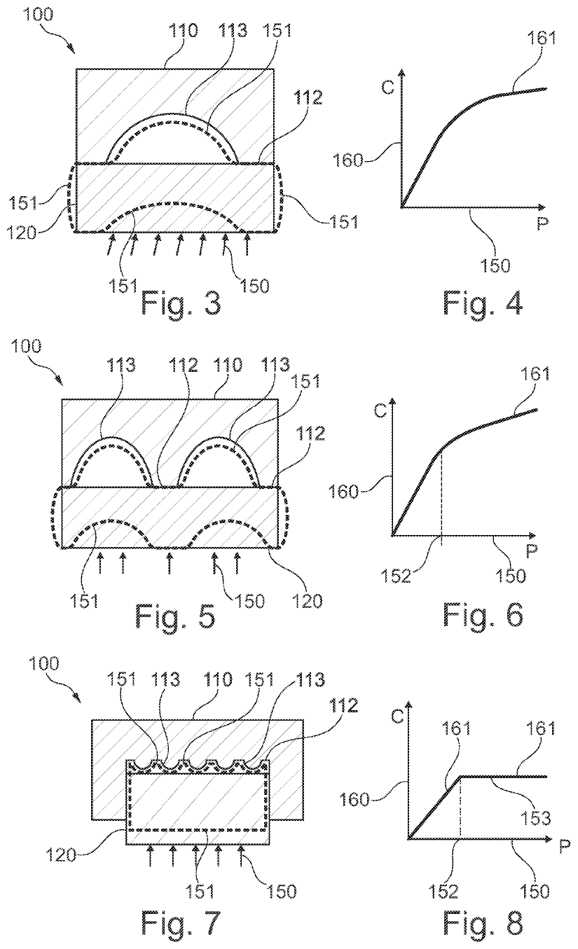

FIGS. 3, 5 and 7 each show a cross-sectional view of a pressure sensor 100 with different sensitivity-increasing and/or measurement range-extending spatial structures 113. FIGS. 4, 6 and 8 show corresponding characteristic curves of the pressure sensors from FIGS. 3,5 and 7.

FIGS. 3, 5 and 7 each show a pressure sensor 100 with a frame element 110 and an electromechanical element 120. By a pressure 150 applied to the electromechanical element 120, the electromechanical element 120 is pressed against a surface 112 of the frame element 110. The applied pressure 150 causes a shape change 151 of the electromechanical element 120.

The surface 112 of the frame element 110 against which the electromechanical element 120 is pressed comprises in each case a sensitivity-increasing and/or measurement range-extending spatial structure 113, which in the absence of pressure 150 forms at least one cavity between frame element 110 and electromechanical element 120. By the pressure 150, the electromechanical element 120 is at least partially pressed into this cavity. The higher the pressure 150, the further the electromechanical element 120 is pressed into the cavity.

In the pressure sensor 100 of FIG. 3, the spatial structure 113 consists of a curved indentation or dome-like indentation or spherical section-shaped indentation in the surface 112. The indentation 113 extends over a wide region of the surface 112. In FIG. 4, a characteristic curve 161 of the pressure sensor 100 from FIG. 3 is shown, which shows the capacitance 160 of the electromechanical element depending on the pressure 150 applied to the electromechanical element.

In the pressure sensor 100 of FIG. 5, the spatial structure 113 consists of two adjacently arranged curved indentations in the surface 112. FIG. 6 shows the corresponding characteristic curve 161 of the pressure sensor 100 from FIG. 5, which reproduces the capacitance 160 of the electromechanical element depending on the pressure 150 applied to the electromechanical element. The change point 152 divides the characteristic curve 161 roughly into two regions. In a first region of lower pressures, the capacitance 160 depends substantially linearly on the applied pressure 150. In a second region of higher pressures, there is likewise substantially linear dependence, wherein the slope of the characteristic curve 161 is smaller than in the first region, which indicates a lower sensitivity of the pressure sensor 100 in this region. At the change point 152, the cavities formed by the spatial structure 113 between the electromechanical element 120 and the frame element 110 are largely filled by the electromechanical element 120.

In the pressure sensor 100 of FIG. 7, the spatial structure 113 consists of a plurality of knob-shaped elevations (or protrusions, or projections) on the surface 112. FIG. 8 shows the corresponding characteristic curve of the pressure sensor 100 from FIG. 7. As in the characteristic curve of FIG. 6, a change point 152 divides the characteristic curve 161 into two regions. Due to the large number of knobs distributed over the entire surface 112, the change point 152 is formed more clearly than in FIG. 6. Also the differences in the slope of the characteristic curve 161 in the two regions are larger. In the region of lower pressures, a linear increase is shown. In the region of higher pressures, a saturation 153 can be seen in which the capacitance hardly changes or no longer changes at all upon pressure increase.

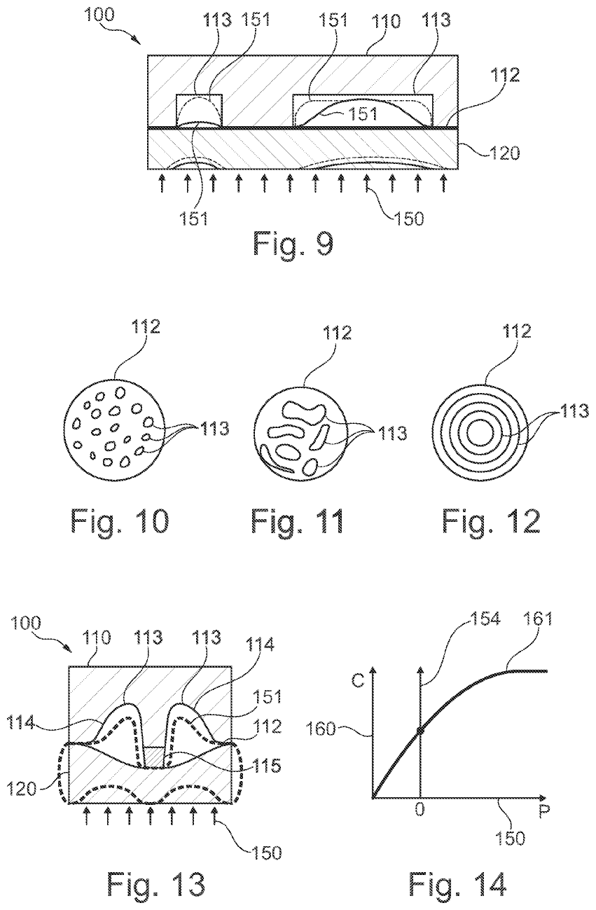

FIG. 9 shows a cross-sectional view of a pressure sensor 100 with a frame element 110 and an electromechanical element 120. By a pressure 150 applied to the electromechanical element 120, the electromechanical element 120 is pressed against a surface 112 of the frame element 110. The applied pressure 150 causes a shape change 151 of the electromechanical element 120.

The surface 112 of the frame element 110 against which the electromechanical element 120 is pressed comprises a sensitivity-increasing and/or measurement range-extending spatial structure 113, which forms two cavities between frame element 110 and electromechanical element 120. These cavities formed by indentations in the surface 112 have different diameters. By the pressure 150, the electromechanical element 120 is at least partially pressed into the cavities. At a low pressure 150, the electromechanical element 120 “flows” primarily into the right cavity with the larger diameter, while only at a higher pressure 150 does the electromechanical element 120 “flow” also into the left cavity with the smaller diameter. By providing cavities with different diameters, a characteristic curve of the pressure sensor can therefore be adjustable in regions of higher and lower pressure.

FIGS. 10, 11 and 12 show top views of different circular surfaces 112 of a frame element against which the electromechanical element is pressed. The surfaces 112 comprise different sensitivity-increasing and/or measurement range-extending spatial structures 113. The structures shown in FIGS. 10, 11 and 12 can each be formed as indentations or as elevations in the surface 112, i.e. concave or convex. FIG. 10 shows a plurality of circular structures 113 which are distributed uniformly over the surface 112. FIG. 11 shows a plurality of elongated structures 113 which are oriented in different directions and are likewise distributed uniformly over the surface. FIG. 12 finally shows concentrically arranged annular structures 113.

FIG. 13 shows a cross-sectional view of a pressure sensor 100 which is constructed analogously to the pressure sensor of FIG. 5. In contrast to the pressure sensor 100 of FIG. 5, an elevation 115 which projects over the surface 112 is arranged between the two indentations 114. The elevation 115 leads to a bias of the electromechanical element 120 in the absence of pressure applied from outside. Such a bias can enable the determination of negative pressures.

FIG. 14 shows a corresponding characteristic curve 161 of the pressure sensor of FIG. 13. The bias leads to a shifted working point 154 in comparison with the pressure sensor of FIG. 5. At the working point 154, no pressure 150 is applied from outside, i.e. p=0.

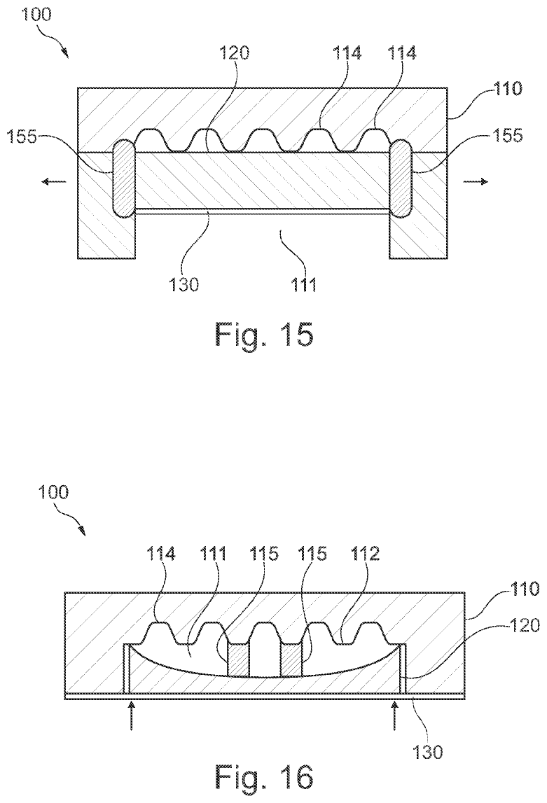

FIGS. 15 and 16 show cross-sectional views of pressure sensors 100 in which a bias is set with different methods. In the pressure sensor of FIG. 15, the bias is set by the electromechanical element 120 being clamped into the frame element 110 at the edges by means of a bias device 155. Descriptively speaking, the electromechanical element is like a drum under tension, as indicated by the arrows in the transverse direction, i.e. in a direction parallel to the surface 112.

In the pressure sensor 100 of FIG. 16, as in the pressure sensor of FIG. 14, a bias of the electromechanical element 120 is set by elevations 115 on the surface 112 of the frame element 110. In other words, the electromechanical element 120 is axially biased by pressure points which are determined by the elevations 115, i.e. in a direction perpendicular to the surface 112. As indicated by the two arrows, the electromechanical element 120 is held by the edge of the membrane 130.

It should be noted that the term “comprise” does not exclude other elements and that the term “a” or “an” does not exclude a plurality. Also, elements which are described in conjunction with different exemplary embodiments can be combined. It should also be noted that reference numerals in the claims should not be interpreted as limiting the scope of protection of the claims.

### REFERENCE NUMERALS

10 Sample separation device or system
20 Fluid pumping system
25 Supply unit
27 Degasser
30 Sample separation unit
40 Sample feeding unit
50 detector
60 Fractionation device
70 Control unit
100 Pressure sensor
110 Frame element
111 Recess
112 surface
113 Spatial structure
114 indentation
115 elevation
116 centering element
117 adjustment element
120 electromechanical element
121 electrically insulating layer
122 electrically conductive layer
123 gap
130 separating element
131 bead
140 base element
150 pressure
151 shape change
152 change point
153 saturation
154 working point
155 bias device
160 capacitance
161 characteristic curve

1. A pressure sensor, comprising:
an electromechanical element configured to change its shape depending on a pressure applied to the pressure sensor, and to output an electromagnetic characteristic that is based on the shape change; and
a frame element comprising a surface against which the electromechanical element is pressed by the applied pressure to cause the shape change.

2. The pressure sensor according to claim 1, wherein a material of the electromechanical element comprises a material selected from the group consisting of: an electroactive polymer; and a dielectric elastomer.

3. The pressure sensor according to claim 1, wherein the electromechanical element comprises an electrically insulating layer and two electrically conductive layers between which the electrically insulating layer is arranged.

4. The pressure sensor according to claim 3, wherein a material of the electrically conductive layers comprises a material of the electrically insulating layer as a matrix material and an electrically conductive filler in the matrix material.

5. The pressure sensor according to claim 1, wherein the electromagnetic characteristic is a capacitance.

6. The pressure sensor according to claim 1, wherein the surface of the frame element against which the electromechanical element is pressed and/or a corresponding surface of the electromechanical element comprises a sensitivity-increasing and/or measurement range-extending spatial structure.

7. The pressure sensor according to claim 6, wherein the spatial structure comprises at least one cavity between the electromechanical element and the frame element, and with increasing applied pressure the electromechanical element is configured to be pressed into the at least one cavity.

8. The pressure sensor according to claim 6, wherein the spatial structure comprises a plurality of indentations and/or a plurality of elevations, which are arranged on and/or in the surface of the frame element against which the electromechanical element is pressed and/or the corresponding surface of the electromechanical element.

9. The pressure sensor according to claim 8, wherein the indentations and/or elevations are arranged concentrically.

10. The pressure sensor according to claim 8, wherein at least two of the indentations and/or at least two of the elevations comprise different geometrical dimensions and/or different distances to an edge of the surface of the frame element.

11. The pressure sensor according to claim 8, wherein a thickness of the electromechanical element is one to ten times, or one and a half times to three times, a profile depth defined by the indentations and/or the elevations.

12. The pressure sensor according to claim 1, comprising one of:
wherein the electromechanical element is configured to be pressed against the frame element with a bias;
wherein the electromechanical element is configured to be pressed against the frame element with a bias to make a negative pressure applied to the pressure sensor measurable.

13. The pressure sensor according to claim 12, wherein the bias is at least partially generated by a membrane, and the membrane is attached to the frame element and at least partially covers the electromechanical element.

14. The pressure sensor according to claim 12, wherein the bias is at least partially generated by the electromechanical element being clamped into the frame element.

15. The pressure sensor according to claim 12, wherein the bias is at least partially generated by an elevation on the surface of the frame element against which the electromechanical element is pressed.

16. The pressure sensor according to claim 1, comprising one of:
a separating element that covers the electromechanical element in a liquid-tight manner;
a separating element that covers the electromechanical element in a liquid-tight manner, wherein the separating element comprises a membrane.

17. The pressure sensor according to claim 16, comprising one of:
wherein the electromechanical element is molded on an abutting surface profile of the separating element;
wherein the electromechanical element is molded on an abutting surface profile of the separating element, and the surface profile comprises a microstructure.

18. The pressure sensor according to claim 1, comprising one of:
wherein the electromechanical element is at least partially introduced into a recess of the frame element;
wherein the electromechanical element is at least partially introduced into a recess of the frame element, and a gap is arranged between a side edge of the recess and the electromechanical element.

19. A sample separation system for separating a fluidic sample located in a mobile phase into fractions, the sample separation system comprising:
a fluid drive configured to drive the mobile phase and the fluidic sample, when located in the mobile phase, along a separation path;
a sample separation unit configured to separate the fluidic sample located in the mobile phase in the separation path; and
the pressure sensor according to claim 1 configured to determine a pressure of the mobile phase and/or the fluidic sample, wherein the pressure sensor is arranged upstream of the fluid drive.

20. A method for determining a pressure, the method comprising:
providing a pressure sensor comprising an electromechanical element and a frame element;
measuring an electromagnetic characteristic of the electromechanical element, wherein the electromagnetic characteristic depends on a shape change of the electromechanical element, and the shape change is caused by the electromechanical element being pressed against a surface of the frame element by a pressure applied to the pressure sensor; and
detecting the applied pressure from the measured electromagnetic characteristic.
